(19) United States
(12) Patent Application Publication
(10) Pub. No.: US 2025/0139693 A1
(43) Pub. Date: May 1, 2025

(54) LISTING INFORMATION REGISTRATION DEVICE, LISTING INFORMATION REGISTRATION METHOD, AND RECORDING MEDIUM

(71) Applicant: Rakuten Group, Inc., Tokyo (JP)

(72) Inventors: Osamu TORII, Tokyo (JP); SangHun LEE, Tokyo (JP); Mina FUJISAWA, Tokyo (JP); Wataru OKAMOTO, Tokyo (JP); Anne JU, Tokyo (JP)

(73) Assignee: Rakuten Group, Inc., Tokyo (JP)

(21) Appl. No.: 18/931,708

(22) Filed: Oct. 30, 2024

(30) Foreign Application Priority Data
Oct. 31, 2023 (JP) 2023-187263

(51) Int. Cl. G06Q 30/08

(52) U.S. Cl. CPC G06Q 30/08

(57) ABSTRACT

A trading management server (listing information registration device) accepts input of an item code associated with an item to be listed, acquires default information to be associated with the accepted item code, displays and outputs a listing information form in which the acquired default information is input as a default value, registers, in a listing information database, a piece of listing information edited in the listing information form, when input of the item code is accepted, retrieves at least one another piece of listing information including the accepted item code from pieces of listing information registered in the listing information database, and displays and outputs, together with the listing information form, summary information of the retrieved at least one another piece of listing information.

### CROSS-REFERENCE TO RELATED APPLICATIONS

This application claims the benefit of Japanese Patent Application No. 2023-187263, filed on Oct. 31, 2023, the entire disclosure of which is incorporated by reference herein.

### FIELD OF THE INVENTION

The present disclosure relates to a listing information registration device, a listing information registration method, and a recording medium.

### BACKGROUND OF THE INVENTION

As a technique for generating an auction item list on an auction site, for example, Unexamined Japanese Patent Application Publication No. 2014-154171 proposes a technique for receiving item identification data uniquely identifying an item and item image data, extracting item attribute data of an item specifying an attribute of an item using the item identification data, and generating auction list data based on both of at least part of the item attribute data and at least part of the item image data.

### SUMMARY OF THE INVENTION

A listing information registration device according to the present disclosure includes a processor, wherein the processor
accepts input of an item code associated with an item to be listed,
acquires default information to be associated with the accepted item code,
displays and outputs a listing information form in which the acquired default information is input as a default value,
registers, in a listing information database, a piece of listing information edited in the listing information form,
when input of the item code is accepted,
retrieves at least one another piece of listing information including the accepted item code from pieces of listing information registered in the listing information database, and
displays and outputs, together with the listing information form, summary information of the retrieved at least one another piece of listing information.

### BRIEF DESCRIPTION OF DRAWINGS

A more complete understanding of this application can be obtained when the following detailed description is considered in conjunction with the following drawings, in which:

FIG. 1 is a block diagram illustrating a configuration of a trading system according to the present embodiment;

FIG. 2 is a diagram illustrating a hardware configuration example of an information processing device constituting the trading system according to the present embodiment;

FIG. 3A is a diagram illustrating one example of listing information;

FIG. 3B is a diagram illustrating one example of item code-to-default information corresponding information;

FIG. 4 is a flowchart illustrating one example of listing processing in a user terminal;

FIG. 5 is a flowchart illustrating one example of listing acceptance processing in a trading management server;

FIG. 6A is a diagram illustrating an example of display on a user terminal;

FIG. 6B is a diagram illustrating an example of display on a user terminal;

FIG. 6C is a diagram illustrating an example of display on a user terminal;

FIG. 6D is a diagram illustrating an example of display on a user terminal;

FIG. 7A is a diagram illustrating an example of display on a user terminal;

FIG. 7B is a diagram illustrating an example of display on a user terminal;

FIG. 7C is a diagram illustrating an example of display on a user terminal;

FIG. 7D is a diagram illustrating an example of display on a user terminal; and

FIG. 8 is a diagram illustrating an example of display on a user terminal.

### DETAILED DESCRIPTION OF THE INVENTION

Hereinafter, a trading system 100 according to an embodiment of the present disclosure is described with reference to drawings. Note that, the same or equivalent parts in the drawings are denoted by the same reference signs.

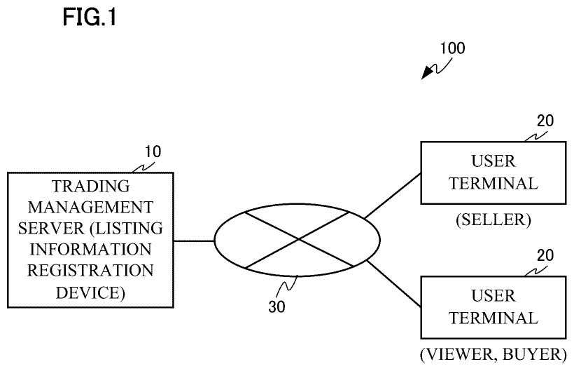

FIG. 1 is a block diagram illustrating a configuration of the trading system 100 according to the present embodiment. The trading system 100 is a system for mediating interpersonal trading between users. The trading system 100 includes a trading management server 10 and a plurality of user terminals 20. The trading management server 10 and the plurality of user terminals 20 are connected via a communication network 30 such as the Internet or a mobile communication network. The trading management server 10 and the plurality of user terminals 20 transmit/receive information via the communication network 30.

In the trading system 100, for example, a user who is an item seller registers information on an item that the user wishes to sell in the trading management server 10 via the user terminal 20, and thereby the user can list the item on a website for interpersonal trading operated by the trading management server 10. A user who is a viewer viewing the listed item can retrieve and view the listed item through the website. A user who is a buyer (prospective buyer) desiring to purchase the viewed item performs a purchasing procedure specifying a purchase price, a payment method, a shipping destination, and the like on the website, and thereby the user can register his/her purchase request for the item in the trading management server 10. When his/her purchase request is registered on the trading management server 10, information about the purchase request and information such as a purchase price, a payment method, a shipping destination, and the like are notified to the seller from the trading management server 10. The seller ships the listed item to the shipping destination notified after confirmation or the like of payment made by the buyer. The above concludes the interpersonal trading in the trading system 100.

Note that, a trading scheme in the trading system 100 may be an auction style in which a prospective buyer specifies a desired purchase price, a flea market style in which a seller specifies a desired sales price, or a mixture thereof. Further, information relating to purchasing such as a payment method, a shipping destination, and a shipping method may be exchanged directly between a seller and a buyer after a purchasing procedure.

The trading management server 10 is also referred to as a listing information registration device for registering listing information. The trading management server 10 has various types of application programs, and achieves various types of functions by executing the various types of application programs. The trading management server 10 accepts listing information from the user terminal 20 of a seller, stores the accepted listing information, and publishes the listing information on a website for interpersonal trading operated by the trading management server 10. That is, the trading management server 10 also functions as a web server providing a website. Note that, the trading management server 10 may be achieved by a plurality of servers for each function. Further, the trading management server 10 accepts a purchase request for an item from the user terminal 20 of a buyer, stores information relating to the accepted purchase request, notifies the information to a seller of the item, and closes the listing of the item. Thereafter, for example, upon accepting a report of transaction completion (an item receipt report, evaluation, and the like) from the user terminal 20 of the seller and the buyer, the trading management server 10 stores that the transaction is concluded.

Further, in the trading system 100 according to this embodiment, when an item is listed by a seller, a barcode attached to the item to be listed or a container, a package, or the like of the item to be listed is read by the user terminal 20, thereby enabling barcode listing specifying the item. The user terminal 20 transmits an item code corresponding to the read barcode to the trading management server 10. The trading management server 10 accepts input of the item code corresponding to the barcode read by the user terminal 20. At this time, based on the received item code, default information (an item name, a list price, a brand, and the like) associated with the item code is acquired, and a listing information form in which the default information is input as a default value (initial value) is displayed and output on the user terminal 20 of the seller. This allows the seller to save time and effort of inputting such information since the default value is input to the item name and the like in the listing information form by simply reading the barcode attached to the item, thus progressing listing work and encouraging a user to list an item. Further, this can prevent uneven content input or incorrect information input by the seller, and allows a viewer and a prospective buyer to easily grasp the listing information. Note that, the default value (initial value) input in the listing information form can be employed as is without the seller editing the value, or can be edited if desired. Note that, while a case has been described in which the trading management server 10 includes, in the own device, a database (a so-called catalog DB) including item information such as the above-described default information, the trading management server 10 may acquire the default information from another server device that stores a database including item information.

Note that, in the trading system 100, barcode listing (item code listing) may be performed by inputting an item code (the number or the like corresponding to a barcode) instead of inputting a barcode by the user terminal 20. In this way, listing of an item specified by an item code can be performed even by the user terminal 20 (a PC or the like) including no barcode reader.

Note that, the barcode may be a Japan article number (JAN) (a domestic global trade item number (GTIN)), an international standard book number (ISBN), a foreign GTIN code, and the like.

Furthermore, upon barcode listing (item code listing), the trading management server 10 according to this embodiment displays and outputs, together with the listing information form in which such default information is input as a default value, summary information that is a summary of at least one another piece of listing information including an accepted item code, thereby providing the summary information to a seller. The summary information of the another piece of listing information may be at least part of information (summary) included in the another piece of listing information, such as item price information and item information of the another piece of listing information. Further, the summary information of the another piece of listing information may be a link for referring to the summary information. Upon listing of an item, a seller can refer to the summary information of the another piece of listing information and thus, upon inputting in the listing information form, the summary information can be used as a reference for what to be filled in or the like, thus further progressing listing work and encouraging listing of an item. Further, according to the trading management server 10, a rich item description or the like can be expected, and thus, activation of transaction can be expected. A detailed content of the trading management server 10 providing summary information of at least one another piece of listing information is described later.

Note that, the trading management server 10 includes, for example, an information processing device capable of communication, such as a personal computer (PC) or a workstation. Note that, the trading management server 10 may be a dedicated device.

The user terminal 20 is an information processing device having a communication function, such as a smartphone, a tablet, or a PC used by a user. The user terminal 20 accepts input of listing information of an item from a seller, and transmits the information to the trading management server 10 via the communication network 30. Further, the user terminal 20 accepts input of information relating to a purchase request for the item from a buyer (prospective buyer), and transmits the information to the trading management server 10 via the communication network 30. Note that, a transaction in the trading system 100 may be performed via a dedicated application installable on the user terminal 20, or may be performed via a general-purpose browser. Further, when barcode listing is performed, the user terminal 20 includes a reader (a camera, a barcode reader, or a barcode scanner) for reading a barcode. Note that, although two user terminals 20 are illustrated in FIG. 1, there may be any number of user terminals 20.

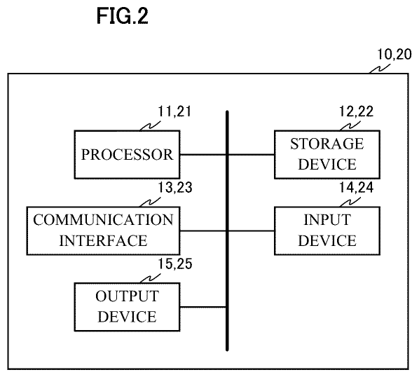

FIG. 2 is a diagram illustrating a hardware configuration example of an information processing device constituting the trading management server 10 and the user terminal 20. The trading management server 10 includes a processor 11 such as a central processing unit (CPU) or a graphical processing unit (GPU), a storage device 12 such as a memory, an HDD, and/or an SSD, a communication interface 13 performing wired or wireless communication, an input device 14 accepting an input operation, and an output device 15 outputting information. The input device 14 is, for example, a keyboard, a touch panel, a camera, a mouse, and/or a microphone. The output device 15 is, for example, a display and/or a speaker.

Similarly, the user terminal 20 includes a processor 21, a storage device 22, a communication interface 23, an input device 24, and an output device 25. The user terminal 20 preferably includes, as the input device 24, a device (a camera, a barcode reader, or the like) capable of reading a barcode to enable barcode listing. Note that, a configuration unnecessary in the trading management server 10 or the user terminal 20 may be omitted as appropriate, or another configuration may be added.

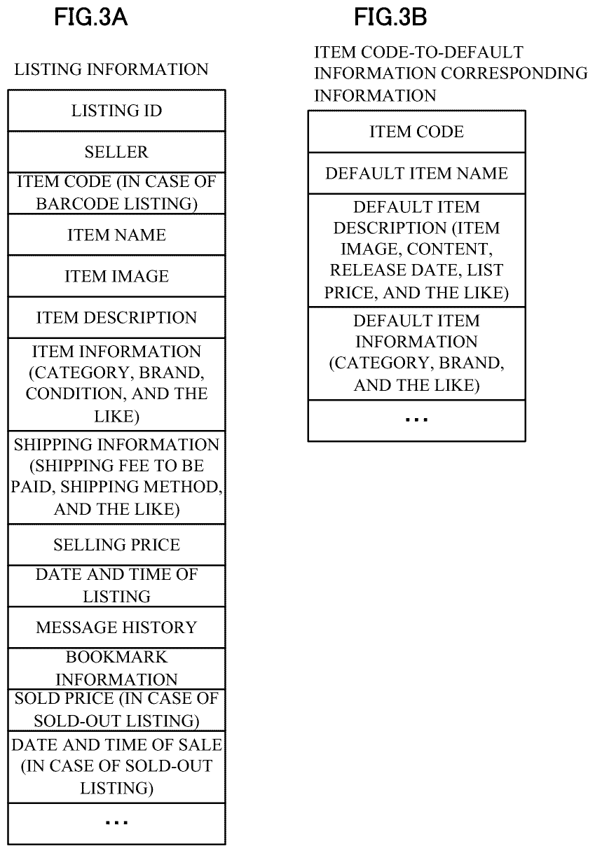

FIGS. 3A and 3B illustrate one example of data stored in the storage device 12 of the trading management server 10. The storage device 12 of the trading management server 10 stores, for example, listing information relating to an item listed by a seller and item code-to-default information corresponding information. FIG. 3A illustrates a configuration example of listing information. The listing information includes, for example, information such as a listing ID for identifying a listing, a seller, an item code of a listed item (in case of barcode listing), an item name, an item image, an item description, item information (a category, a brand, a condition, and the like), shipping information (a shipping fee to be paid, a shipping method, and the like) at a time of purchase, a selling price, date and time of listing, a message history such as question and answer relating to a listing, bookmark information (the number of bookmarks, favorites, and likes or the like) by a viewer, a sold price (in case of a sold-out listing), and date and time of sale (in case of a sold-out listing). When an item is listed by a seller, the listing information is stored in the storage device 12 of the trading management server 10, based on information input by the user terminal 20. Further, when exchange of a message about the listing occurs, when the listing is bookmarked by a viewer, when the item description, the selling price, or the like is edited by the seller, and when the sale is concluded or the like, the listing information is updated according to a content thereof. The storage device 12 of the trading management server 10 as described above stores a plurality of pieces of listing information of listings registered on the trading management server (listing information registration device) 10. The storage device 12 storing a plurality of pieces of listing information or accumulation of data thereof is also referred to as a listing information database.

FIG. 3B illustrates a configuration example of item code-to-default information corresponding information. The default information is, for example, information in which default information such as a default item name, a default item description (an item image, a content, a release date, a list price, and the like), and default item information (a category, a brand, and the like) is associated with an item code corresponding to a barcode attached to an item or a package of an item. The default information may be information edited in such a way as to adapt to the present system, based on data acquired from a manufacturer or a specialized agency. The default information is, for example, information edited in such a way as to correspond to a content (an item description, item information, and the like) of listing information to be published on a website for interpersonal trading. Note that, data configurations illustrated in FIGS. 3A and 3B are examples and may include, for example, another piece of information.

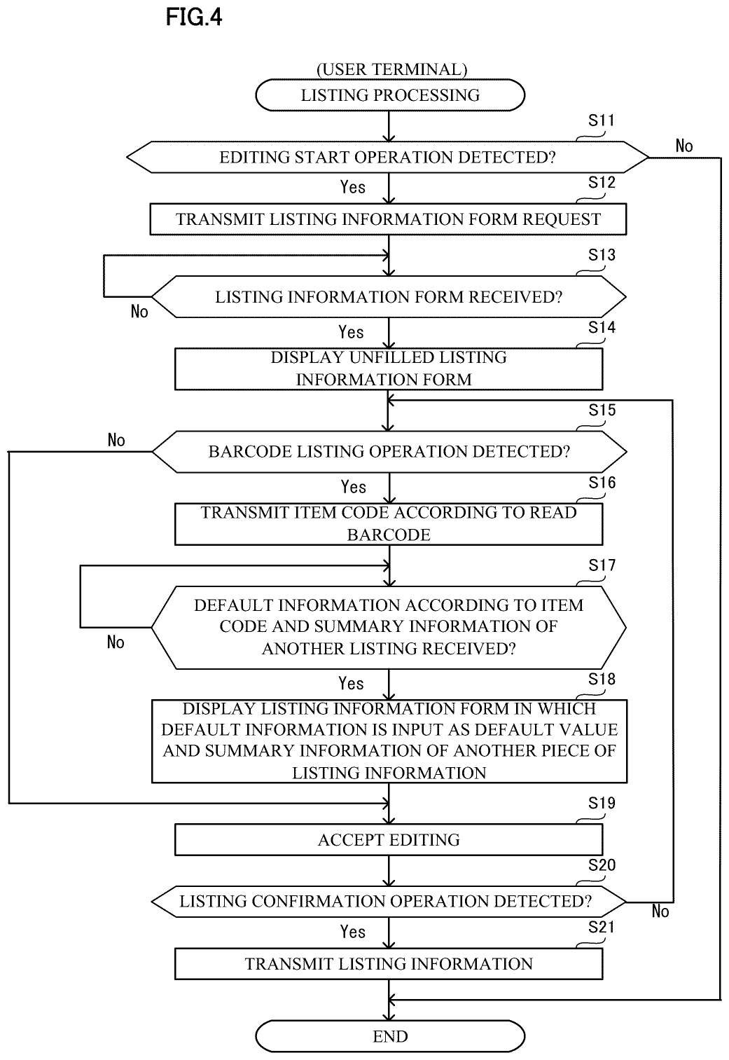

Next, an operation relevant to listing in the trading system 100 is described. FIG. 4 is a flowchart illustrating one example of listing processing executed in the user terminal 20. The listing processing is executed by, for example, the processor 21 of the user terminal 20 reading a program stored in the storage device 22. In the listing processing, the processor 21 of the user terminal 20 determines whether an editing start operation of listing information has been detected (Step S11). The editing start operation of listing information is an operation for starting editing of listing information that is information on an item to be listed by using a listing information form, and is, for example, an operation of launching an application in the user terminal 20 for buying and selling an item in the trading system 100 and selecting a listing start field in the application. When the editing start operation of listing information has not been detected (Step S11; No), the processor 21 ends the listing processing.

When the editing start operation of listing information has been detected (Step S11; Yes), the processor 21 transmits, to the trading management server 10, a request for acquiring a listing information form for inputting listing information (Step S12). Then, the processor 21 stands by until receiving a listing information form from the trading management server 10 (Step S13).

When receiving the listing information form from the trading management server 10 (Step S13; Yes), the processor 21 displays the received listing information form on a display of the user terminal 20 (Step S14). The listing information form includes unfilled fields.

Next, the processor 21 determines whether a barcode listing operation has been detected (Step S15). The barcode listing operation is, for example, an operation of selecting barcode listing in the listing information form, an operation of reading a barcode on an item to be listed, or an operation of inputting an item code corresponding to a barcode.

When the barcode listing operation has been detected (Step S15; Yes), the processor 21 transmits, to the trading management server 10, an item code corresponding to a read barcode (Step S16). In Step S16, the processor 21 may convert, for example, a barcode on an item to be listed read by a camera or the like of the user terminal 20 into an item code (number) according to a predetermined algorithm, and may transmit the converted item code to the trading management server 10. Further, when an item code of an item to be listed is input manually, the processor 21 may transmit the item code as is to the trading management server 10. In this way, the item code may be read mechanically, or may be input manually by a seller.

Thereafter, the processor 21 stands by until receiving default information according to the item code and summary information of at least one another piece of listing information from the trading management server 10 (Step S17).

When receiving default information and summary information of at least one another piece of listing information from the trading management server 10 (Step S17; Yes), the processor 21 displays, on the display of the user terminal 20, the listing information form in which the received default information is input as a default value and the summary information of the another piece of listing information (Step S18). In Step S18, the processor 21 automatically fills in a field corresponding to the default information with a default value corresponding to the default information in the listing information form already acquired from the trading management server 10. Then, at this time, the processor 21 displays the summary information of the another piece of listing information together.

After the processing of Step S18 or when the barcode listing operation has not been detected (Step S15; No), the processor 21 accepts editing from a user for each field in the listing information form (Step S19). In Step S19, the processor 21 accepts input or selection of information in the listing information form with the input device 24, and temporarily stores the accepted information.

Thereafter, the processor 21 determines whether a listing confirmation operation based on information input to the listing information form has been detected (Step S20). The listing confirmation operation is, for example, a confirmation operation after inputting information to all required fields in the listing information form and a subsequent listing operation. When the listing confirmation operation has not been detected (Step S20; No), the processing returns to Step S15, and the processor 21 continues accepting a barcode listing operation or accepting editing of the listing information form.

Note that, the listing information form that is being edited or has been edited may be saved as a draft. In this case, the draft may be read out later to perform a listing confirmation operation, thereby enabling the listing of an item.

When the listing confirmation operation has been detected (Step S20; Yes), the processor 21 transmits, to the trading management server 10, listing information corresponding to the information input to the listing information form (Step S21), and ends the listing processing.

Through the above listing processing, a seller can register listing information on the trading management server 10 by using the user terminal 20, and, as a result, can publish a listing according to the listing information on a website for interpersonal trading.

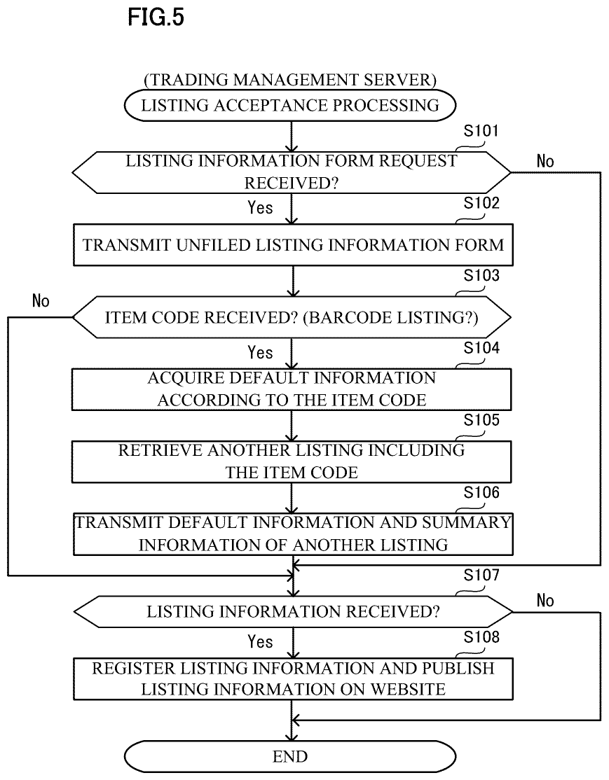

FIG. 5 is a flowchart illustrating one example of listing acceptance processing executed in the trading management server 10. The listing acceptance processing is executed by, for example, the processor 11 of the trading management server 10 reading a program stored in the storage device 12. In the listing acceptance processing, the processor 11 of the trading management server 10 determines whether a request for acquiring a listing information form has been received from the user terminal 20 (Step S101).

When the request for acquiring a listing information form has been received (Step S101; Yes), the processor 11 transmits a listing information form including unfilled fields in such a way that the user terminal 20 being a transmission source of the acquisition request can display and output the listing information form (Step S102).

Next, the processor 11 determines whether an item code has been received from the user terminal 20 to which the listing information form has been transmitted (Step S103). That is, the processor 11 determines whether a barcode listing operation has been performed in the user terminal 20.

When the item code has been received from the user terminal 20 (Step S103; Yes), the processor 11 refers to item code-to-default information corresponding information in the storage device 12, thereby acquiring default information (a default item name, a default item description, default item information, and the like) corresponding to the item code (Step S104).

Further, the processor 11 refers to a listing information database in the storage device 12, thereby retrieving listing information of another listing, including the item code (Step S105). In Step S105, the processor 11 may retrieve, for example, at least one another piece of listing information including an item code matching with the item code received this time. Note that, the another piece of listing information to be retrieved may include at least any of listing information of a listing still for sale and listing information of a listing previously for sale and now sold out. For example, from the listing information of a sold listing, an exact sales price, a duration of the listing, and the like can be acquired, and by providing the listing information to a seller, the seller can grasp a past market price for selling and the like. Further, from the listing information of a listing still for sale, a latest market price for selling and the like can be acquired, and by providing the listing information to a seller, the seller can grasp a current market price for selling and the like.

Then, the processor 11 transmits, to the user terminal 20 being a transmission source of the item code, the default information acquired in Step S104 and the summary information of the at least one another piece of listing information retrieved in Step S105 (Step S106). Thereby, the listing information form in which the default information is input as a default value can be displayed and output on the user terminal 20 being a transmission source of the item code. In conjunction therewith, the summary information of the another listing can be displayed and output on the user terminal 20.

Note that, the trading management server 10 not only retrieves at least one another piece of listing information including an item code matching with the item code received this time and provides summary information of the retrieved another listing, but also may retrieve at least one another piece of listing information of an item similar to an item of a listing of this time, based on default information (for example, a default item name or the like) specified from the item code received this time. Then, the trading management server 10 may provide the summary information of the retrieved at least one another piece of listing information to the user terminal 20. In this way, the trading management server 10 can provide, to a seller, summary information about an item that has a different item code but includes the same item (in a different package or a different version), an item in a different color of the same item, or the like. This allows the trading management server 10 to provide summary information of listing information of a similar item to a seller, even when, for example, there are few or no other pieces of listing information including an item code matching with the item code received this time.

After execution of the processing of Step S106, when the request for acquiring a listing information form has not been received (Step S101; No), or when the item code has not been received (Step S103; No), the processor 11 determines whether a piece of listing information has been received from the user terminal 20 (Step S107). The listing information corresponds to a content of the filled (edited) listing information form. When listing information has not been received from the user terminal 20 (Step S107; No), the processor 11 ends the listing acceptance processing.

When the listing information has been received from the user terminal 20 (Step S107; Yes), the processor 11 registers the received listing information in the listing information database (the storage device 12), and publishes a listing corresponding to the listing information in a viewable way on a website for interpersonal trading (Step S108). Thereafter, the processor 11 ends the listing acceptance processing.

Through the above listing acceptance processing, the trading management server 10 can provide default information according to an item code and summary information of another listing to the user terminal 20 being a transmission source of the item code, can support a user inputting listing information, and can encourage enrichment of an input content. Further, the trading management server 10 can publish a listing according to listing information received from the user terminal 20 on a website for interpersonal trading.

Note that, the trading management server 10 also executes processing of accepting a purchase request from the user terminal 20 and notifying a seller of the purchase request (processing for establishing an interpersonal trading service provided by the trading management server 10) or the like, although omitted herein because the present embodiment relates to a listing registration device supporting registration of listing information.

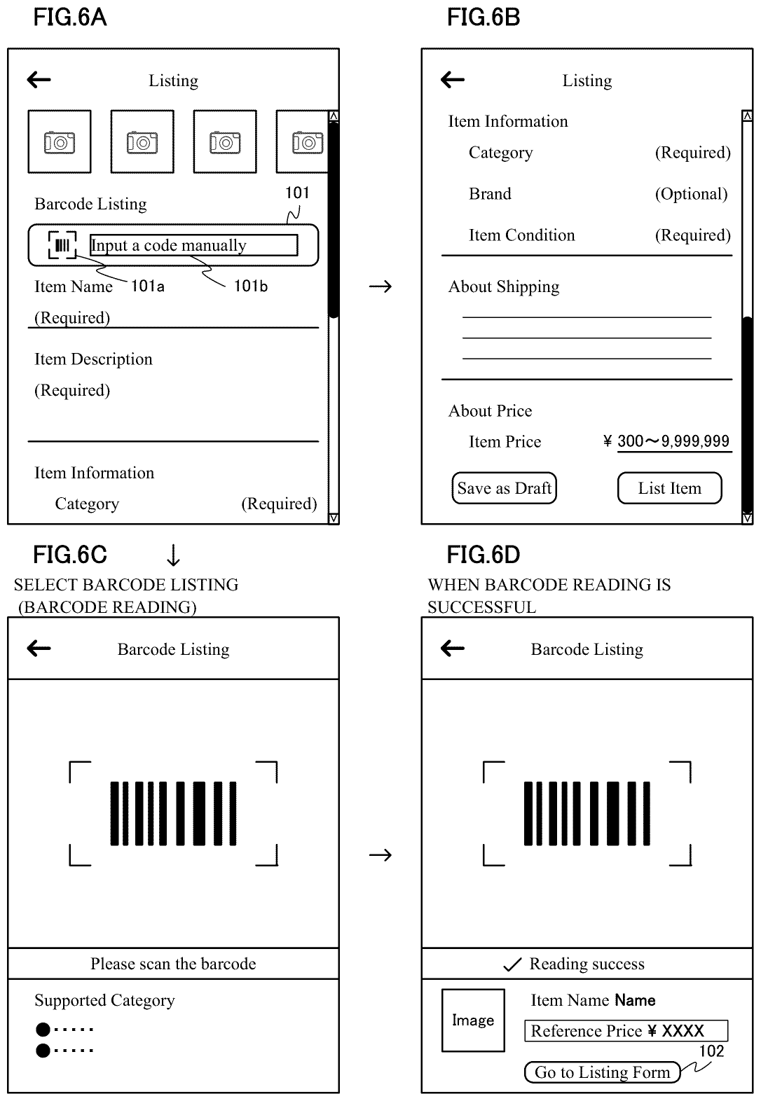

Next, a display example relating to a function of registering listing information in the trading system 100 according to the present embodiment is described by using FIGS. 6A to 6D, 7A to 7D, and 8. Herein, a display example of a display on a smartphone as the user terminal 20 is described.

It is assumed that a flea market app for mediating interpersonal trading via the Internet is installed on a smartphone. When a user who is a seller launches the flea market app and performs an editing start operation of listing information by operating a list item button displayed on the display or the like, a screen of a listing information form for editing listing information is displayed, as illustrated in FIG. 6A. On the screen (a top screen of an edit screen to be displayed after operating the list item button), icons for uploading images indicated by images of cameras on top of FIG. 6A, an operator 101 for performing barcode listing, an “Item Name” input field, an “Item Description” input field, an “Item Information” input field, and the like are displayed. When the screen is scrolled, the “Item Information” input field in the listing information form, an “About Shipping” (shipping information) input field, an “About Price” (item price) input field, a “Save as Draft” button, and a “List Item” button are displayed, as illustrated in FIG. 6B. Note that, the fields included in the listing information form are one example, and, for example, another field may be included.

When the icon for uploading an image is touch-operated, for example, the screen transitions to a screen for uploading an image saved in the smartphone or an image newly captured by a camera. Further, for example, any item name can be input to the “Item Name” input field. Any item description text can be input to the “Item Description” input field. An item category, a brand, an item condition (new, used, or a condition in case of used), and the like can be input to or selected in the “Item Information” input field. A shipping method, a shipping fee to be paid, a length of time for shipping, and the like can be input to the “About Shipping” (shipping information) input field. An item price within a price range set in advance (300 to 9,999,999 yen in this example) can be input to the “About Price” (item price) input field. When the “Save as Draft” button is operated, listing information input until then is saved as a draft. When the “List Item” button is operated, the input fields are checked and are displayed when correctly filled in, and a screen for selecting whether to confirm the listing of the content is displayed.

In the screen illustrated in FIG. 6A, when a barcode icon 101a within the operator 101 for performing barcode listing is selected, the camera of the smartphone is activated and a screen for reading a barcode is displayed, as illustrated in FIG. 6C. In the screen, a frame for guiding a position where an image to be captured by the camera and a barcode fit, a description of an item category supporting barcode listing, and the like are displayed. Herein, when the seller successfully reads a barcode on a package or the like of an item to be listed with the camera, an item code corresponding to the barcode is transmitted to the trading management server 10, and, in response thereto, the user terminal 20 receives default information according to the item code from the trading management server 10. In this case, display indicating that the barcode has been successfully read is displayed, and an item image, an item name, a reference price, and the like of an item specified by the barcode are displayed based on the received default information, as illustrated in FIG. 6D. In a screen illustrated in FIG. 6D, a return button 102 for “Go to Listing Form” is displayed.

In the screen illustrated in FIG. 6A, when an item code of an item to be listed is input to a text box 101b for inputting a code manually within the operator 101 for performing barcode listing, the item code is transmitted to the trading management server 10, and, similarly to when reading a barcode, an item image, an item name, a reference price, and the like of an item corresponding to the item code are displayed, as illustrated in FIG. 6D. Note that, the reference price may be calculated from a list price of the item, a market price for purchasing, or the like. The reference price may be stored in advance as default information in item code-to-default information corresponding information.

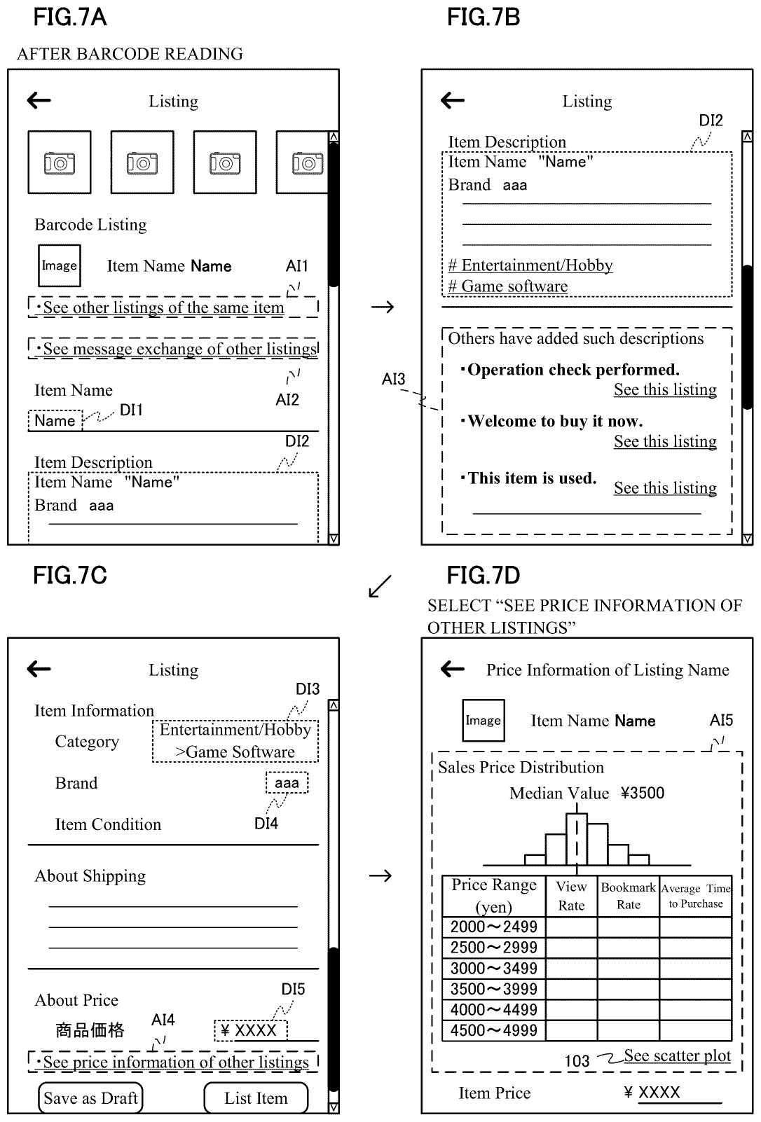

In the screen illustrated in FIG. 6D, when the return button 102 for “Go to Listing Form” is operated, a screen of the listing information form in which the default information according to the item code (barcode) is input as a default value is displayed, as illustrated in FIG. 7A. When the screen is scrolled, screens of the listing information form illustrated in FIGS. 7B and 7C are displayed and output. In FIGS. 7A to 7C, a default value DI1 (in the figure, “Name”) as the “Item Name”, a default value DI2 (in the figure, Item name “Name”, Brand aaa, tags, and the like) as the “Item Description”, a default value DI3 (in the figure, Entertainment/Hobby>Game Software) as the category of the “Item Information”, a default value DI4 (in the figure, “aaa”) as the brand, and a default value DI5 (in the figure, “YXXXX”) as the item price are filled in. In this way, in barcode listing, the default value according to the item code is automatically input to the listing information form, and thus, the seller can input accurate listing information without time and effort of inputting information. Note that, the input contents or fields to be filled in illustrated in FIGS. 7A to 7C are one example, and each default value corresponding to each item code is automatically input.

Further, in this embodiment, when the seller performs barcode listing, the trading management server 10 displays and outputs summary information of at least one another piece of listing information including the item code of the listing, thereby providing the summary information to the seller. In the listing information form in which the default value as illustrated in FIGS. 7A to 7C is input after the operation of barcode listing, as summary information of at least one another piece of listing information including the item code of the listing, additional information not included in default information corresponding to the item code is displayed. As such additional information, for example, a link AI1 to a sales page for purchasing an item of another piece of listing information, a link AI2 to negotiation information (Q&A, a discount negotiation, an evaluation content, a complaint, and the like) relating to a message exchanged between another seller and a prospective buyer who has wished to purchase another item when the another item has been listed, difference information AI3 of when the item description in which the default value is input is edited by another seller who has listed another item of another piece of listing information, and a link AI4 to price information of another listing are displayed, as illustrated in FIGS. 7A to 7C.

When the link AI1 to a sales page for purchasing an item of another piece of listing information is operated, for example, a sales page for another listing of the same item as the item operated for barcode listing this time is displayed. This allows the seller to refer to an item information text or an item price through the sales page for the another listing, and the sales page can be used as a reference for inputting the own listing information. As a result, a rich content of listing information can be expected, and improvement in possibility of trading conclusion can be expected. Further, increase in commission income can be expected as a management side of the trading system 100. Note that, when there is a plurality of other listings including an item code of a listing at this time and the link AI1 is operated, a list of the other listings (a list of links to sales pages) including the item code may be displayed.

When the link AI2 to negotiation information relating to a message exchanged between another seller and a prospective buyer who has wished to purchase another item when the another item has been listed is operated, exchange of a (published) message between a seller and a prospective buyer of another listing can be referred to. For example, the seller can easily grasp an appropriate price by viewing exchange of a price negotiation and can easily grasp a point of interest for a prospective buyer or a demand in an electronic market by viewing a question, an evaluation, or a complaint of the prospective buyer, and the negotiation information can be used as a reference for inputting the own listing information.

In the difference information AI3 when the item description in which the default value is input is edited by another seller who has listed another item of at least one another piece of listing information, for example, a difference text that is included in the item description of another listing and is not included in the default value of the item description, such as “Operation check performed.”, “Welcome to buy it now.”, and “This item is used.”, is displayed, as illustrated in FIG. 7B. This allows the seller to grasp the item description added by another seller to the default value, and the difference text can be used as a reference for additionally inputting the item description. Note that, In FIG. 7B, a link to a sales page for the listing, such as “See this listing”, is displayed next to the text of the difference information AI3. This allows the seller to easily refer to a sales page of another listing and also refer to the another piece of information (an item price or the like) of the another listing.

Further, the trading management server 10 highlights phrases such as “Operation check performed.”, “Welcome to buy it now.”, and “This item is used.” that are not included in the default information in the text of the difference information AI3. This allows the seller to easily and simply grasp the phrases added in the item description of another listing, and can support the seller to add the item description. Note that, the trading management server 10 may highlight phrases that are not included in the default information but frequently appear in the difference information of when the item description in which the default value is input is edited.

When the link AI4 to price information of another listing is operated, for example, information AI5 relating to a sales price distribution of an item intended for barcode listing at this time is displayed, as illustrated in FIG. 7D. For example, the trading management server 10 extracts and tabulates pieces of listing information for which trading has been concluded among other listings including an item code of an item intended for barcode listing at this time, and displays a sales price distribution thereof, a median value, and the like with a graph and a table, as illustrated in FIG. 7D. In FIG. 7D, the sales price distribution and the median value are indicated with a graph. This allows the seller to grasp a market price for selling in a simplified way, and the graph can be used as a reference for determination of the selling price. Further, in FIG. 7D, view rate (for example, the number of views per day) to a price range, bookmark rate (for example, percentage of bookmarks to the number of viewers), and an average time to purchase are indicated with a table. The seller can infer that the higher the rate of views or bookmarks, the more popular the item per se is and the more likely the item is to be sold. Further, the seller can determine the range of appropriate prices according to the average time to purchase. For example, the seller can determine that the price is lower than the appropriate price when the average time to purchase is extremely short.

Note that, the price information of another listing is not limited to a graph or a table indicating the price distribution as illustrated in FIG. 7D, but may be a numerical representation of the price distribution, an average price, the lowest, highest, and median values of the sales price, a reference price based on analysis thereof, and the like, or may be a representation of the price information in another image expression. Further, the rate of bookmarks illustrated in FIG. 7D may be bookmark information relating to at least any of a length of time between when another item is listed and when the another item is bookmarked and the number of bookmarks.

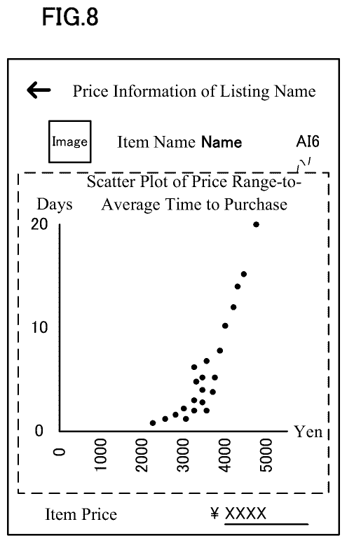

When a link 103 to “See Scatter Plot” is operated in the information AI5 relating to the sales price distribution in FIG. 7D, a scatter plot AI6 of the price range to the average time to purchase is displayed, as illustrated in FIG. 8. This allows the seller to determine an appropriate price range according to the scatter plot AI6. Further, the seller can grasp that the higher the price is set, the longer the time to purchase is, according to the scatter plot AI6 as in FIG. 8. Then, in the trading system 100, this can reduce a case in which the sales price is set higher than the appropriate price and a listing that is difficult to conclude trading remains unsold for a long period of time. Note that, the scatter plot is not limited to the scatter plot of the price range to the average time to purchase, and may be used as a reference for pricing by the seller, such as a scatter plot of the price range to the number of views or a scatter plot of the price range to the average time to bookmark.

Note that, the information AI5 relating to the sales price distribution illustrated in FIG. 7D and the scatter plot AI6 illustrated in FIG. 8 are not limited to being displayed as information on a link destination from the listing information form, but may be displayed on the listing information form. Similarly, information (information on a link destination of the link AI1) on a sales page for purchasing an item of at least one another piece of listing information and negotiation information (information on a link destination of the link AI2) relating to a message exchanged between another seller and a prospective buyer who has wished to purchase another item when the another item has been listed may be displayed on the listing information form.

Note that, while a case has been described in FIGS. 6A to 6D, 7A to 7D, and 8 in which listing of an item on a website for interpersonal trading is performed by a smartphone in which a flea market app has been installed, listing of an item on a website for interpersonal trading may be performed from a PC, or may be performed by a general-purpose browser without using an app. Even in this case, when barcode listing or listing by inputting an item code is performed by a seller, the trading management server 10 may provide, to the user terminal 20 such as a PC or a smartphone, a listing information form in which default information according to an item code is input as a default value, and may provide summary information of at least one another piece of listing information including the item code together with the listing information form.

### Modified Example

Note that, the disclosure is not limited to the above embodiment, but various modifications and applications are possible. For example, omission or replacement of a part of the above embodiment, addition of any configuration, and the like are possible.

The summary information of at least one another piece of listing information according to an item code to be provided to a seller is not limited to the information exemplified in the above embodiment, but may be any information (summary) included in at least one another piece of listing information. The information may be information useful when a user performs listing of an item.

According to the above embodiment, upon receiving an item code, the trading management server 10 retrieves at least one another piece of listing information including the item code, and transmits summary information of the retrieved at least one another piece of listing information to the user terminal 20. Without limitation thereto, the trading management server 10 may retrieve similar listing information based on information (for example, an item name) input in a listing information form, and may transmit summary information of the retrieved at least one another piece of listing information to the user terminal 20. In this case, even when barcode listing or item code listing is not performed, the trading management server 10 can provide, to a seller, summary information of listing information of another item similar to an item to be listed that the seller wishes to sell.

According to the above embodiment, barcode listing can be performed during editing of a listing information form by a seller after the listing information form is acquired by the user terminal 20, but barcode listing (or item code listing) may be performed by specifying barcode listing at a time of starting editing of listing information. In this case, when barcode listing is specified at a time of starting editing of listing information, the user terminal 20 may transmit, to the trading management server 10, a request for acquiring a listing information form including an item code according to a read barcode. Then, the trading management server 10 may transmit, to the user terminal 20, a listing information form in which default information according to an item code is input as a default value. That is, as a result, any procedure may suffice, as long as a listing information form in which default information according to an item code input by a seller is input as a default value can be provided to the seller.

The trading management server 10 can be achieved by using an ordinary computer, not by using a dedicated device. For example, the trading management server 10 executing the above-described processing may be configured by installing, on a computer, a program for executing the above-described function from a recording medium in which the program is stored. Further, one trading management server 10 may be configured by a plurality of computers operating in cooperation.

Further, while an example in which the trading management server 10 functions as a listing information registration device has been described, a system configuration is not limited thereto. For example, a listing information registration device may be provided separately from a server that manages trading of listing information registered by the listing information registration device. Specifically, a listing information registration device (server) having a function of registering listing information accepted from the user terminal 20 in a listing information database, accepting input of an item code associated with an item to be listed that a seller wishes to sell, and providing a listing information form in which a default value according to the item code has been input and summary information of at least one another piece of listing information may be provided separately from a server that manages trading of listing information.

The user terminal 20 can be achieved by using an ordinary computer, not by using a dedicated device. For example, the user terminal 20 executing the above-described processing may be configured by installing, on a computer included in a terminal device, a program for executing the above-described function via a communication network.

Further, any approach to supply a program to a computer may be employed. For example, a program may be supplied via a storage medium, a communication line, a communication network, a communication system, or the like. For example, a non-transitory computer-readable recording medium in which a program for executing the above-described function is stored may be distributed.

A non-transitory recording medium can be distributed and sold independently of a computer. Herein, the non-transitory recording medium refers to a tangible recording medium. The non-transitory recording medium is, for example, a compact disc, a flexible disk, a hard disk, a magneto-optical disk, a digital video disc, a magnetic tape, a semiconductor memory, or the like. Further, a transitory recording medium indicates a transmission medium (propagation signal) per se. The transitory recording medium is, for example, an electrical signal, an optical signal, an electromagnetic wave, or the like. Note that, a temporary storage area is an area for temporarily storing data or a program, and is, for example, a volatile memory such as a random access memory (RAM).

Further, when a part of the above-described function is provided by an operation system (OS), a part other than the function provided by the OS may be provided by a program.

The embodiment described above is intended for ease of understanding the present disclosure, and is not intended for interpreting the present disclosure in a limited way. The flowcharts and the sequences described in the embodiment, the elements included in the embodiment, and the arrangements, materials, conditions, shapes, sizes and the like of the elements are not limited to the illustrations, but can be changed as appropriate. Further, the configurations illustrated in different embodiments can be partially substituted or combined with each other.

### Disclosure Achieved by Present Example

As described above, the present embodiment achieves the following disclosure.

### Appendix 1

A listing information registration device comprising a processor, wherein the processor accepts input of an item code associated with an item to be listed,
acquires default information to be associated with the accepted item code,
displays and outputs a listing information form in which the acquired default information is input as a default value,
registers, in a listing information database, a piece of listing information edited in the listing information form,
when input of the item code is accepted,
retrieves at least one another piece of listing information including the accepted item code from pieces of listing information registered in the listing information database, and
displays and outputs, together with the listing information form, summary information of the retrieved at least one another piece of listing information.

### Appendix 2

The listing information registration device according to appendix 1, wherein, when input of the item code is accepted, the processor further retrieves at least one another piece of listing information of an item similar to an item specified by the item code from pieces of listing information registered in the listing information database, and further displays and outputs summary information of the retrieved at least one another piece of listing information.

### Appendix 3

The listing information registration device according to appendix 1 or 2, wherein
the summary information of the at least one another piece of listing information includes additional information not included in the acquired default information, and
the additional information includes a link to a sales page for purchasing an item of the at least one another piece of listing information.

### Appendix 4

The listing information registration device according to any one of appendices 1 to 3, wherein
the summary information of the at least one another piece of listing information includes additional information not included in the acquired default information, and
the additional information includes a distribution of a sales price included in the at least one another piece of listing information.

### Appendix 5

The listing information registration device according to any one of appendices 1 to 4, wherein
the summary information of the at least one another piece of listing information includes additional information not included in the acquired default information, and
the additional information includes difference information of when the default value is edited by another seller who has listed another item of the at least one another piece of listing information.

### Appendix 6

The listing information registration device according to appendix 5, wherein the processor highlights a phrase not included in the acquired default information among pieces of the difference information.

### Appendix 7

The listing information registration device according to any one of appendices 1 to 6, wherein
the summary information of the at least one another piece of listing information includes additional information not included in the acquired default information, and
the additional information includes negotiation information relating to a message exchanged between another seller and a prospective buyer who has wished to purchase the another item when the another item is listed.

### Appendix 8

The listing information registration device according to any one of appendices 1 to 7, wherein
the summary information of the at least one another piece of listing information includes additional information not included in the acquired default information, and
the additional information includes bookmark information relating to at least any of a length of time between when the another item is listed and when the another item is bookmarked and a number of bookmarks.

### Appendix 9

The listing information registration device according to any one of appendices 1 to 8, wherein the at least one another piece of listing information includes at least any of listing information of a listing still for sale and listing information of a listing previously for sale and now sold out.

### Appendix 10

A listing information registration method to be executed by a listing information registration device, comprising:
accepting input of an item code associated with an item to be listed;
acquiring default information to be associated with the accepted item code;
displaying and outputting a listing information form in which the acquired default information is input as a default value;
registering, in a listing information database, a piece of listing information edited in the listing information form;
when input of the item code is accepted,
retrieving at least one another piece of listing information including the accepted item code from pieces of listing information registered in the listing information database; and
displaying and outputting, together with the listing information form, summary information of the retrieved at least one another piece of listing information.

### Appendix 11

A non-transitory computer-readable recording medium that stores a program causing a computer to execute processing of:
accepting input of an item code associated with an item to be listed;
acquiring default information to be associated with the accepted item code;
displaying and outputting a listing information form in which the acquired default information is input as a default value;
registering, in a listing information database, a piece of listing information edited in the listing information form;
when input of the item code is accepted,
retrieving at least one another piece of listing information including the accepted item code from pieces of listing information registered in the listing information database; and
displaying and outputting, together with the listing information form, summary information of the retrieved at least one another piece of listing information.

According to the present disclosure, a listing information registration device, a listing information registration method, and a recording medium that can suitably support input of listing information can be provided.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. A listing information registration device comprising a processor, wherein the processor accepts input of an item code associated with an item to be listed,
acquires default information to be associated with the accepted item code,
displays and outputs a listing information form in which the acquired default information is input as a default value,
registers, in a listing information database, a piece of listing information edited in the listing information form,
when input of the item code is accepted,
retrieves at least one another piece of listing information including the accepted item code from pieces of listing information registered in the listing information database, and
displays and outputs, together with the listing information form, summary information of the retrieved at least one another piece of listing information.

2. The listing information registration device according to claim 1, wherein, when input of the item code is accepted, the processor further retrieves at least one another piece of listing information of an item similar to an item specified by the item code from the pieces of listing information registered in the listing information database, and further displays and outputs summary information of the retrieved at least one another piece of listing information.

3. The listing information registration device according to claim 1, wherein
the summary information of the at least one another piece of listing information includes additional information not included in the acquired default information, and
the additional information includes a link to a sales page for purchasing an item of the at least one another piece of listing information.

4. The listing information registration device according to claim 1, wherein
the summary information of the at least one another piece of listing information includes additional information not included in the acquired default information, and
the additional information includes a distribution of a sales price included in the at least one another piece of listing information.

5. The listing information registration device according to claim 1, wherein
the summary information of the at least one another piece of listing information includes additional information not included in the acquired default information, and
the additional information includes difference information of when the default value is edited by another seller who has listed another item of the at least one another piece of listing information.

6. The listing information registration device according to claim 5, wherein the processor highlights a phrase not included in the acquired default information among pieces of the difference information.

7. The listing information registration device according to claim 1, wherein
the summary information of the at least one another piece of listing information includes additional information not included in the acquired default information, and
the additional information includes negotiation information relating to a message exchanged between another seller and a prospective buyer who has wished to purchase the another item when the another item is listed.

8. The listing information registration device according to claim 1, wherein
the summary information of the at least one another piece of listing information includes additional information not included in the acquired default information, and
the additional information includes bookmark information relating to at least any of a length of time between when the another item is listed and when the another item is bookmarked and a number of bookmarks.

9. The listing information registration device according to claim 1, wherein the at least one another piece of listing information includes at least any of listing information of a listing still for sale and listing information of a listing previously for sale and now sold out.

10. A listing information registration method to be executed by a listing information registration device, comprising:
accepting input of an item code associated with an item to be listed;
acquiring default information to be associated with the accepted item code;
displaying and outputting a listing information form in which the acquired default information is input as a default value;
registering, in a listing information database, a piece of listing information edited in the listing information form;
when input of the item code is accepted,
retrieving at least one another piece of listing information including the accepted item code from pieces of listing information registered in the listing information database; and
displaying and outputting, together with the listing information form, summary information of the retrieved at least one another piece of listing information.

11. A non-transitory computer-readable recording medium that stores a program causing a computer to execute processing of:
accepting input of an item code associated with an item to be listed;
acquiring default information to be associated with the accepted item code;
displaying and outputting a listing information form in which the acquired default information is input as a default value;
registering, in a listing information database, a piece of listing information edited in the listing information form;
when input of the item code is accepted,
retrieving at least one another piece of listing information including the accepted item code from pieces of listing information registered in the listing information database; and
displaying and outputting, together with the listing information form, summary information of the retrieved at least one another piece of listing information.
